(19) United States
(12) Patent Application Publication
(10) Pub. No.: US 2025/0106637 A1
(43) Pub. Date: Mar. 27, 2025

(54) MOBILE DEVICE, METHOD FOR ASSIGNING A SECURITY LEVEL OF A MOBILE DEVICE, AND METHOD FOR DETERMINING A POSITION

(71) Applicant: Infineon Technologies AG, Neubiberg (DE)

(72) Inventors: Walther Pachler, Graz (AT); Dominic Peter Pirker, Graz (AT); Reinhold Schmidt, Graz (AT)

(21) Appl. No.: 18/892,747

(22) Filed: Sep. 23, 2024

(30) Foreign Application Priority Data
Sep. 25, 2023 (DE) 10 2023 209 328.6

(51) Int. Cl. H04W 12/67; H04W 12/08; H04W 12/63

(52) U.S. Cl. CPC H04W 12/67; H04W 12/08; H04W 12/63

(57) ABSTRACT

A mobile device is provided. The mobile device has a processor and a radio receiver that is configured to receive reflections of a radio pulse, the processor being configured to perform or prompt determination of a reflection pattern based on received reflections, to undertake or prompt classification of a position based on the determined reflection pattern and at least one previously detected reference reflection pattern, and being configured to prompt an action based on a result of the classification.

### REFERENCE TO RELATED APPLICATIONS

This application claims priority to German Patent Application 10 2023 209 328.6, filed on Sep. 25, 2023, the contents of which are hereby incorporated by reference in their entirety.

### TECHNICAL FIELD

The invention relates to a mobile device, a method for assigning a security level of a mobile device, and a method for determining a position.

### BACKGROUND

Ultra-wideband technology (UWB) is a type of short-range radio communication that uses extremely large frequency ranges having a bandwidth of at least 500 MHz or of at least 20% of the arithmetic mean of the lower and upper cutoff frequencies of the frequency band used.

### SUMMARY

UWB is being used increasingly, in particular for data-protected distance determination with high accuracy, transmission of the signals required for this purpose requiring very little energy.

In addition, a very stable connection is provided that suffers little or no interference even in a very busy RF transmission environment.

Moreover, because UWB uses low-(repetition-) frequency pulses having long wavelengths, it is better able to penetrate solids such as walls and doors than other distance determination technologies that are typically used.

In view of these characteristics, in particular the possibility of undertaking data-protected distance determination, multiple applications can be addressed: entry/access control, a real-time localization service (RTLS), personnel and user device tracking, indoor navigation and a control system that functions by means of target and trigger.

Data-protected distance measurement involves a first UWB device transmitting a data packet to a second UWB device. Distance measurement/determination is also referred to as “ranging”.

The second device receives the data packet and transmits a response back to the first device, which receives it together with all the stored transmission and reception times.

The first device can then send a third data packet, containing a device ID and time stamp for transmitting the first packet, receiving the response from the second device and for transmitting the third data packet, to the second device, which is configured to use this information and its own data reception times to determine its range from the first device.

If the time stamps for which the second device has received the first or the third data packet from the first device are conveyed to the first device, the first device can use them to independently determine its range from the second device. Alternatively or additionally, the second device can transmit the determined range to the first device.

An important challenge for the first and second devices relates to the determination of the time stamps when receiving the data.

This is because their respective radio receivers, which are configured to receive the UWB signals, receive noise on which the signal received by the respective other device is overlaid. Typically, threshold-based detection is used, possibly in conjunction with windowing or averaging. The threshold value is typically set above the noise level. If the detected signal exceeds the threshold value, the assigned time can be considered to be the time stamp. Overall, determining the exact time stamp is a complex operation.

Received signals that are not used for determining the time stamp during range determination, that is to say essentially all received signals that are received after the threshold value is first exceeded, are typically ignored or deleted as soon as the ranging (range determination) is complete.

### BRIEF DESCRIPTION OF THE DRAWINGS

Exemplary embodiments of the invention are illustrated in the figures and are explained in more detail below.

In the figures:

FIG. 1 shows an illustration of a scenario in which a mobile device according to various exemplary embodiments receives reflections of a radio pulse emitted by an external radio transmitter;

FIG. 2 shows a schematic representation of a mobile device according to various exemplary embodiments;

FIG. 3 shows a graphical representation of signals received in a mobile device according to various exemplary embodiments when a short radio pulse is transmitted and partially reflected from an environment;

FIG. 4 shows an illustration of a method for assigning a security level of a mobile device according to various exemplary embodiments, for example using a mobile device according to various exemplary embodiments;

FIG. 5 shows an illustration of how FIGS. 5A-5B relate to one another;

FIGS. 5A-5B show an illustration of a method for assigning a security level of a mobile device according to various exemplary embodiments (including training), for example using a mobile device according to various exemplary embodiments; and

FIG. 6 shows an illustration of a method for assigning a security level of a mobile device according to various exemplary embodiments, for example using a mobile device according to various exemplary embodiments;

FIG. 7 shows a flowchart for a method for assigning a security level of a mobile device according to various exemplary embodiments;

FIG. 8 shows a flowchart for a method for determining a position according to various exemplary embodiments.

### DETAILED DESCRIPTION

In the detailed description that follows, reference is made to the accompanying drawings, which form part of said description and show, for illustration, specific embodiments in which the invention can be performed. In this respect, directional terminology such as “at the top”, “at the bottom”, “at the front”, “at the rear”, “front”, “rear”, etc. is used with reference to the orientation of the described figure(s). Since components of embodiments can be positioned in a number of different orientations, the directional terminology is used for illustration and is not restrictive in any way. It goes without saying that other embodiments can be used, and structural or logical changes can be made without departing from the scope of protection of the present invention. It goes without saying that the features of the various illustrative embodiments described herein can be combined with one another, unless specifically stated otherwise. The detailed description that follows should therefore not be interpreted in a restrictive sense, and the scope of protection of the present invention is defined by the attached claims.

Within the scope of this description, the terms “connected” and “coupled” are used to describe both a direct and an indirect connection and direct or indirect coupling. In the figures, identical or similar elements are provided with identical reference signs if expedient.

In various exemplary embodiments, received signals that, although received in the course of a range determination operation, are not used directly for range determination (and are thus, to a certain extent, additional signals) are also used.

These additional signals contain information about an environment of the receiving device (because they are typically formed by signals associated with the original signal that are reflected by environment objects) and a transmission channel and can thus be used in various exemplary embodiments for stipulating different security levels of an application.

Alternatively or additionally, in various exemplary embodiments, the additional signals can be used to determine a position.

In other words, received reflections of a radio pulse can be detected and evaluated as a “snapshot” or “fingerprint” of an environment in order to assign or release different security levels for an application.

In various exemplary embodiments, a mobile device is provided. The mobile device has a processor, a memory, and a radio receiver that is configured to receive reflections of a radio pulse. The memory storing instructions that are executable by the processor, wherein the execution of the instructions by the processor cause the processor to perform or prompt determination of a reflection pattern on the basis of received reflections, to undertake or prompt classification of a position that the mobile device is in on the basis of the determined reflection pattern and at least one previously detected reference reflection pattern, and to assign a security level of the mobile device on the basis of the classification of the position.

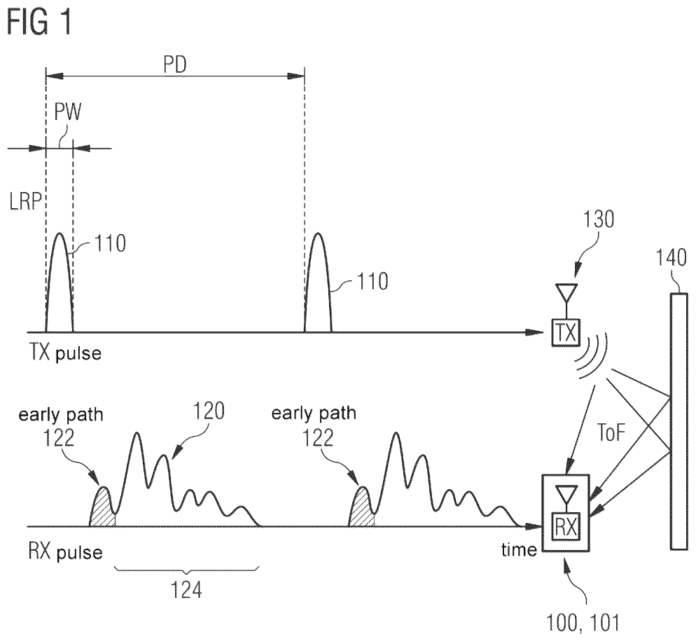

FIG. 1 shows a scenario in which a mobile device 100 or 101 according to various exemplary embodiments receives radio signals 120 that are attributable to radio pulses 110 emitted by an external radio transmitter 130.

The radio signals 120 (also referred to as the channel impulse response (CIR) or impulse response) are composed of a signal 122 (also referred to as the early path 122) transmitted directly between the (in this case external) transmitter 130 and a radio receiver of the mobile device 100, 101 and one or more reflections of the emitted radio pulse 110 received subsequently or following the directly transmitted signal.

In various exemplary embodiments, the radio pulse 110 (abbreviated to: pulse) can be repeatedly emitted by the radio transmitter 130, the repetition rate being able to vary. For example, a low repetition rate can be selected. Accordingly, the radio pulse 110 can also be referred to as the LRP pulse 110, LRP standing for “Low Rate Pulse Repetition Frequency”, that is to say for a low repetition frequency at the pulse rate, for example in a range from approximately 2 MHz to approximately 4 MHz.

The respective radio pulses 110 emitted by the radio transmitter 130 can be referred to as short or as ultra-short. This can facilitate high instantaneous peak performance.

For example, a pulse width PW of the radio pulses may be much smaller than the distance PD between successive radio pulses 110. This allows an image of the channel impulse response to be received in the mobile device 100, 101, for example without reflections of different radio pulses 110 overlapping one another.

In various exemplary embodiments, the pulse width PW may be ≤0.1.PD, e.g. PW≤0.07·PD.

In various exemplary embodiments, the pulse width PW may be in a range from 1 nm to 5 nm, for example around 3 nm. The distance PD between successive radio pulses 110 may typically be in a range from approximately 250 nm to approximately 500 nm, for example.

In FIG. 1, the time characteristics of the radio signals 120 are represented as separate undulating structures received in the mobile device 100, 101 with a time offset compared with the radio pulse 110.

These can be understood symbolically as a combination of the directly transmitted pulse (illustrated by means of the straight arrow between the radio transmitter 130 and the mobile device 100, 101), which is received as the early pulse 122, and various signals reflected by environment structures 140 (here, by way of illustration, a single wall), the reflections 124.

Provided that the radio transmitter 130 and the mobile device 100, 101 are (at least temporarily/periodically, e.g. currently) stationary relative to one another and also the environment structures 140 do not move, or move only insignificantly, the structure of the radio signals 120 is substantially stable, thus repeating itself substantially for successive radio pulses 110.

Accordingly, the structure of the radio signals 120 can be considered to be a “fingerprint” for these absolute positions of the mobile device 100, 101 and the radio transmitter 130 in combination with the associated environment structures 140.

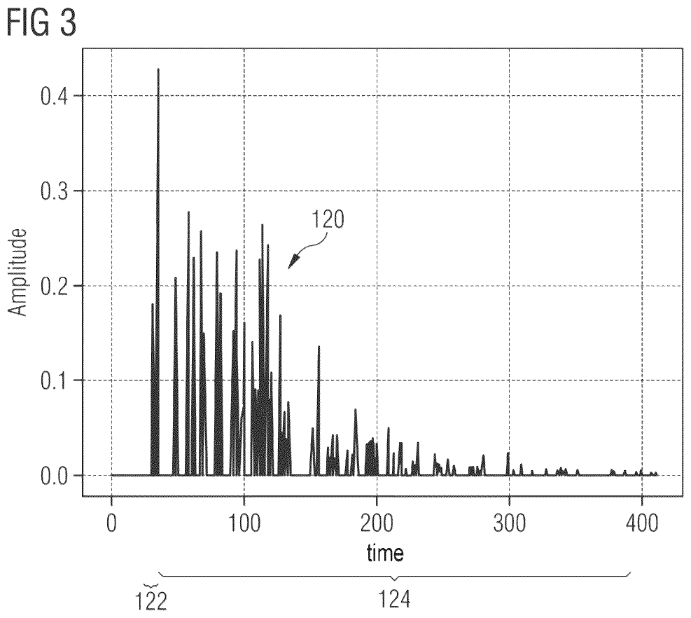

FIG. 3 provides a more detailed graphical representation of radio signals 120 (as a time-resolved amplitude) that are received in a mobile device 100, 101 according to various exemplary embodiments when a short radio pulse 110 is transmitted in range of the mobile device 100, 101 and partially reflected from an environment (e.g. environment structures 140). In this illustrative case, the radio signals 120 were recorded in an environment around a residential building, and each reflection (amplitude peak in the graph after the first one to two peaks, which correspond to the direct path and thus the early pulse 122) corresponds to an environment structure 140 (e.g. an object) from which the radio signal 110 was reflected to the mobile device 100, 101. The sequence of peaks shown is therefore characteristic of the environment of the mobile device 100, 101 (and, if the radio signals 120 are transmitted by a radio transmitter 130 and not by the mobile device 100, 101, also of this).

In various exemplary embodiments, the thus available unique environmental information is used to define or use security levels in computer-aided applications such as a mobile device 100.

An illustrative application is a smart lock that, for example, regulates, that is to say permits, denies, or permits under additional conditions, entry directly to a mobile device 100 such as a vehicle or that, for example, is part of a static facility such as a residential building and is coupled to a mobile device 100, the combination of the smart lock and the mobile device 100 being able to regulate, for example permit, deny or permit under additional conditions, entry.

Similarly, physical entry to a safe, access to application settings, etc. could be controlled, for example.

Another illustrative application is determining a position of a mobile device 101, for example within a spatially enclosed structure such as a shopping center.

Since the mobile device 100 described above, for which, according to various exemplary embodiments, security levels are defined, is structurally identical or substantially identical to the mobile device 101 for position determination, and both differ in a design of the processor 204 (or the mobile device 100, 101 may even be configured for both applications), FIGS. 1 to 3 serve to illustrate both mobile devices 100, 101.

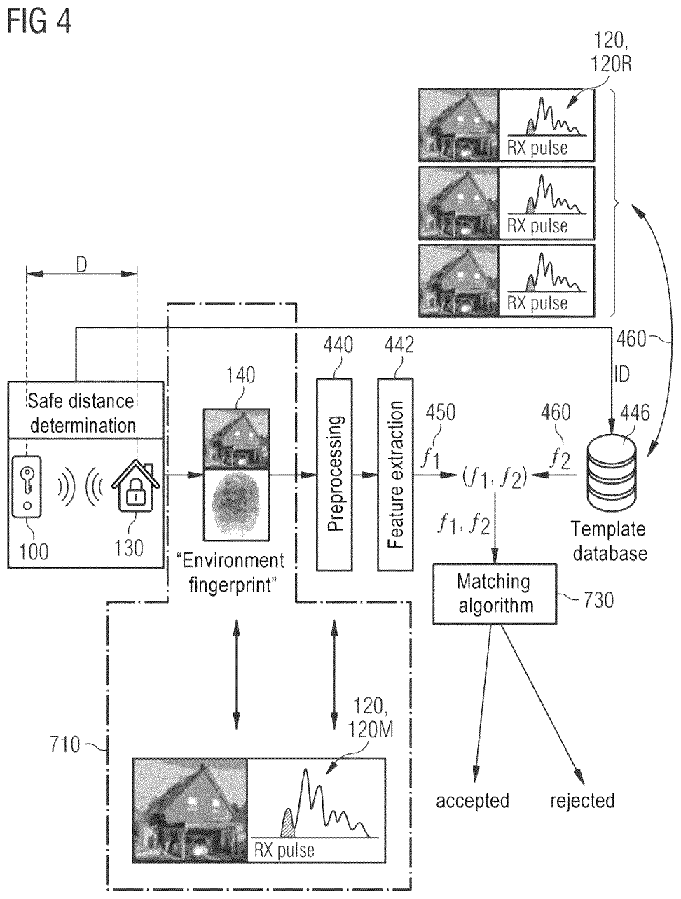

With reference in particular to FIGS. 4 to 7, the text below provides a more detailed explanation of the mobile device 100, to which, according to various exemplary embodiments, security levels are assigned (and optionally security measures accommodated to the assigned security level are carried out).

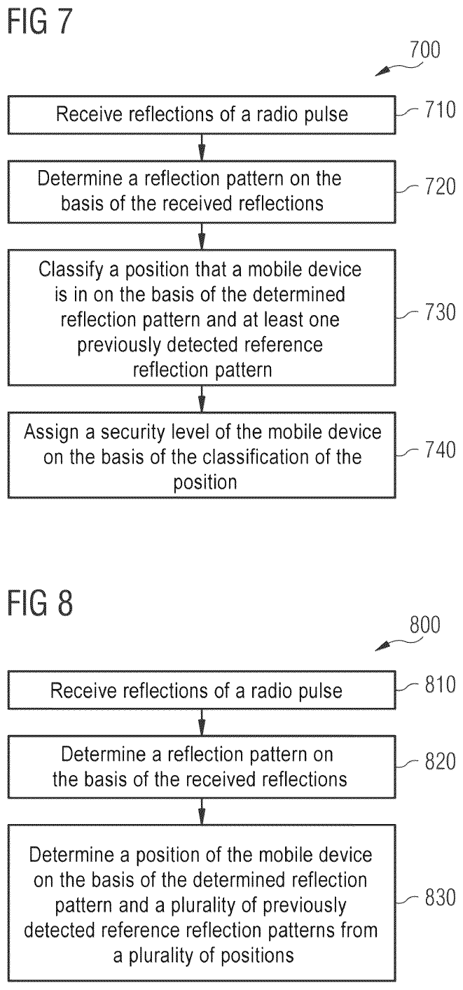

A brief explanation of the mobile device 101, or of the method for determining a position carried out by means of the mobile device 101, then follows with reference to FIG. 8.

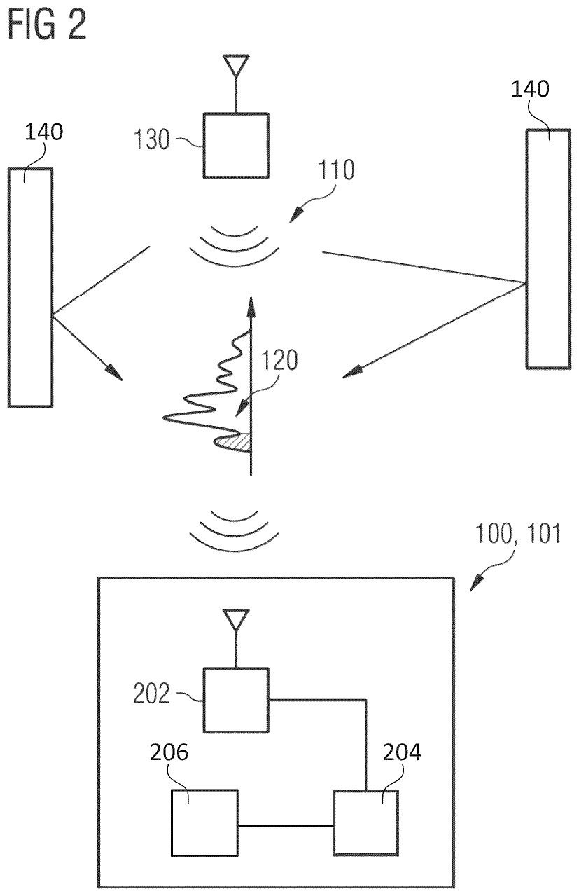

The mobile device 100 according to various exemplary embodiments is shown in FIG. 2. A method that the mobile device 100 uses to assign the security level of the mobile device 100 is illustrated by way of example in FIG. 4.

The mobile device 100 has a processor 204, a memory 206 that stores instructions that are executable by the processor 204, and a radio receiver 202 that is configured to receive reflections of a radio pulse 110. The radio receiver 202 may, for example, be configured to receive UWB signals, which have been explained briefly above, in particular for a so-called “ranging” function that is executable according to a standard, for example according to IEEE 802.15.4/802.15.4z.

In some examples, the processor 204, a memory 206, and radio receiver 202 can be a single standalone chip and 202, 204, 206 are on a single die, but in other examples components 202, 204, 206 are on multiple dies stacked over one another or arranged within a single integrated circuit package in the form of a so-called 3-dimensional IC. In still other examples, 202, 204, 206 may be formed on multiple packaged chips and/or discrete components on a printed circuit board (PCB) arranged within a housing. Components 202, 204, 206 can thus be coupled by wires or buses, such as metal traces on a PCB and/or metallization interconnect layers of an integrated circuit die(s). A die may include a semiconductor substrate, such as a monocrystalline silicon substrate or a silicon on insulator substrate, but can also and/or alternatively include other semiconductor materials, such as gallium arsenide (GaAs), indium gallium arsenide (InGaAs), and germanium (Ge), among others. Further, the chip(s) can include transistors arranged to specifically carry out the functions of the processor and memory; and/or can be programmed with software or firmware instructions to carry out functions of the processor and memory. The memory can be read only memory (ROM), one-time programmable memory (e.g., fuses), or other non-volatile memory that stores the instructions in some examples. In some cases (e.g., ROM and fuses), the structural patterns present in the memory represent the bits of the executable instructions and differ from structural patterns of other memories that have other executable instructions.

As a further alternative, although data packets and additional information can be transmitted according to the standard, it is possible to dispense with determining range at least in either the mobile device 100 or the radio transmitter 130.

In various exemplary embodiments, it is alternatively possible to use short radio pulses 110, which are not explicitly aimed at range determination, but rather are aimed—for example additionally or exclusively—at producing the reflections for characterizing the environment.

In various exemplary embodiments, the processor 204, which, for example, may be a main processor or comprise a main processor or one or more arbitrary suitable processors, and/or, for example, a processor for performing cryptographic services, for example a secure element, may be configured to perform or prompt determination of a reflection pattern on the basis of received reflections using the instructions stored in the memory.

In this case, “prompt” is intended to be understood to mean that the processor 204 may be configured, in various exemplary embodiments, to offload the determination of the reflection pattern, for example to a cloud, another data processing device, or the like. Thus, in some cases, the instructions has a minimal set of instructions, which does not in and of itself determine the reflection pattern, but rather only offloads the determination of the reflection pattern to the cloud and/or another processing device. For data transmission, a (for example cryptographically secured) data connection may be provided in the mobile device 100, for example as a wireless or wired connection.

The explanation above in regard to “prompt” also applies, mutatis mutandis, to a classification, undertaken or prompted by means of the processor 204, of the position that the mobile device 100 is in on the basis of the determined reflection pattern and at least one previously detected reference reflection pattern 460.

The assignment of the security level of the mobile device on the basis of the classification of the position can also be carried out by instructions that are executed by the processor 204 itself, for example, or initiated and offloaded by said processor, e.g. to an external data processing device, e.g. a cloud.

Alternatively, the stated operations can be carried out by the processor 204 itself, or some of the processes can be carried out by processor 204 and others offloaded, for example the determination of the reflection pattern can be carried out by the processor 204 and the classification of the position can be carried out in a cloud (and the result can be reported to the processor 204 if necessary), or in any other useful combination.

The text below presents the processes on the basis of exemplary embodiments as if they were carried out by the processor 204 itself. Unless it is explicitly ruled out that performance of said processes is merely prompted by the processor 204 and carried out by an instance external to the processor, this should be understood as included.

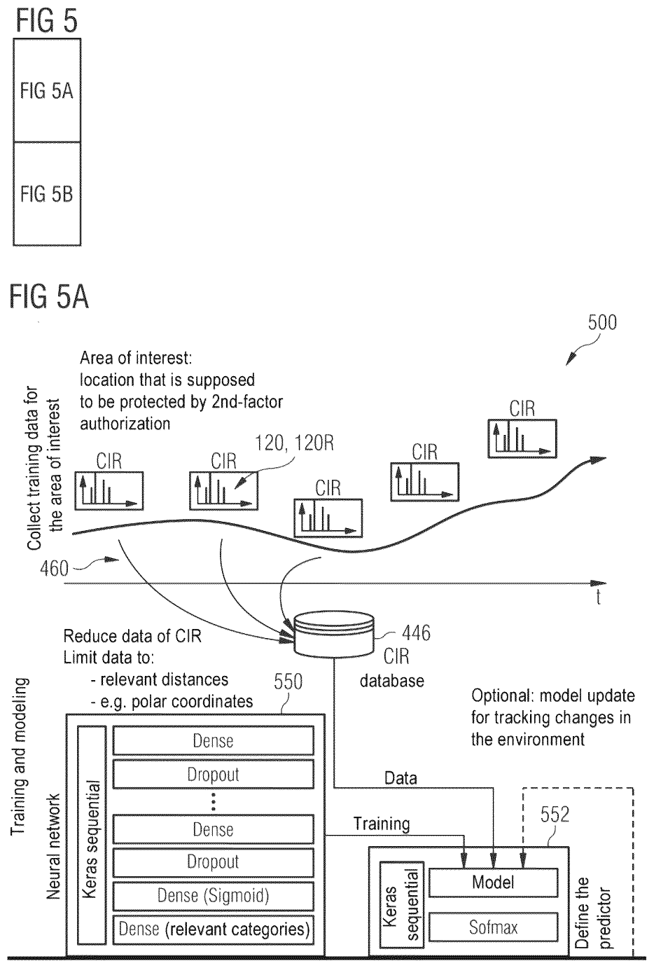

In various exemplary embodiments, the receiving of the reflections 124 may comprise time-resolved measurement of intensities of the reflections 124. This is illustrated in FIG. 1, FIG. 3, FIG. 4 and FIGS. 5A-5B, for example at 710 in FIGS. 4 and 5B. There, the radio signal 120 is sometimes additionally denoted by 120M in order to distinguish a radio signal 120, currently received for matching, that has been provided in order to gain or grant entry to a protected area, for example, from radio signals 120, which are additionally denoted by 120R in FIGS. 4 and 5, that have been provided beforehand in order to create a template database 446 as in FIG. 4 for a direct comparison, or an impulse response database 446, and, on the basis of that, an artificial intelligence model (at 552 in FIG. 5A). Thus, the various elements and/or components of the figures can be carried out in hardware and/or software, with the various elements and/or components being implemented in circuitry including transistors and/or other circuit elements to achieve the described functionality.

To determine the reflection pattern 450, reflections 124 of a radio pulse 110 can also be distinguished from reflections 124 of a subsequent radio pulse 110. This can be made possible, for example, as a result of the pulse width PW being significantly shorter than the distance PD between two successive radio pulses 110. This is because the received reflections 124 of the first radio pulse 110 may already be too weak to be perceptible over the noise (or may not exist, because there are no environment structures 140 within the appropriate range for the associated propagation time extension) before the reflections 124 of the subsequent radio pulse 110 are detected at the radio receiver 202 of the mobile device 100.

Distinguishing the reflections 124 that are assigned to different radio pulses 110 can allow, firstly, all reflections 124 (and indeed only those) that are attributable to this radio pulse 110 to actually be detected as such and, secondly, reflections 124 that are attributable to different radio pulses 110 to be collectively evaluable when determining the reflection pattern 450, for example by means of summing or averaging per unit time, in order to improve a signal-to-noise ratio.

In various exemplary embodiments, it is alternatively or additionally possible to combine two or more successive time units, for example by means of a sliding window, in order to improve a signal-to-noise ratio and/or to reduce a volume of data that is to be processed further.

The above measures can be referred to as preprocessing 440 when determining the reflection pattern 450 and can be applied optionally.

In various exemplary embodiments, the (optional) preprocessing 440 or the reception of the reflections 124 may optionally be followed by a downstream feature extraction 442.

The feature extraction 442 can be geared for example to particularly distinctive, stable features for the reflections 124, for example relevant distances, e.g. reflection clusters (in FIG. 3, around the time index 110, for example), and/or areas in which reflections are missing (in FIG. 3, at time index 140, for example), and/or amplitude ratios, for example greatly different amplitudes or approximately the same amplitudes. Polar coordinates, for example, can be used.

The mobile device 100 may have a memory in which the determined reflection pattern 450 can be stored.

The mobile device 100, in particular the processor 204, may further be configured to undertake or prompt classification 730 of a position that the mobile device 100 is in on the basis of the determined reflection pattern 450 and at least one previously detected reference reflection pattern 460.

The at least one reference reflection pattern 460 may have previously been detected by virtue of the mobile device 100 receiving reflections 124 at at least one position, which is supposed to serve as a reference, at least once in a calibration mode, pre-treating said reflections as described for the determined reflection pattern 450 if necessary, and/or extracting features and storing said features in the database 446.

Optionally, this operation may have been performed multiple times, and/or for different positions. Security levels may have been assigned to the positions within the calibration mode or subsequently.

A comparison (matching) can thus be carried out to classify the position that the mobile device 100 is in (730), in order to determine whether or not the determined reflection pattern 450 matches a reference reflection pattern 460 (also referred to as a template) stored in the database 446.

In FIG. 4, the classification 730 is described generally as a “matching algorithm” and may comprise, for example, a direct comparison (e.g. determining the square of the differences between the reflection pattern 450 and at least one (e.g. all stored) reference reflection pattern 460).

A drop below a predefined threshold value can be counted as a hit, a difference above the threshold value as a non-hit.

Similarly, a comparison of extracted and standardized stored features, for example, can be made: a high number of matches (if applicable 100%) can be counted as hits, fewer or no matches as non-hits.

The classification (the matching algorithm) 730 from FIG. 4 can alternatively or additionally be carried out using artificial intelligence. This is described in more detail in FIG. 5.

The database 446 is initially filled as described above, e.g. with reference to FIG. 4.

The reference reflection patterns 460 stored in the database 446 are then not used directly for comparison with the detected reflection pattern 450, however, but rather as training data for a classification model created by means of artificial intelligence (AI), for example using a neural network, e.g. by means of machine learning.

FIGS. 5A-5B, illustrates a Keras sequential model by way of example. In various exemplary embodiments, however, any other useful Al model can be used.

The Al model is then used to carry out the actual classification of the position that the mobile device is in (730).

The matching 730, which compares a newly provided “environment fingerprint” comprising reflections 124—the reflection pattern 450—with one or more provided reference reflection patterns 460, can be described clearly using the better known matching of fingerprints, as the options for proceeding in this case have parallels:

A comparison of fingerprints in image form on the basis of raw data with images of reference fingerprints stored in databases is possible, albeit time consuming. This would correspond to the direct comparison of the raw reflection pattern data.

It may sometimes be necessary to pretreat the fingerprints, for example in order to separate structures of the fingerprint from those of a background. This corresponds to the preprocessing 440 of the raw reflection pattern data outlined above.

And a faster and less data-intensive comparison option is also used for fingerprints in the form of a feature extraction that involves special structures in the print (e.g. whorls) being noted and compared in a standardized manner-similarly to the feature extraction 442 outlined above.

The reference reflection patterns 460 may have been assigned classifications, for example classifications that may relate to a security level. FIGS. 5A-5B presents examples of this: For example, a high security level may be assigned for access to a vehicle (the mobile device 100) when a reflection pattern 450 matching its own garage is recognized, whereas a medium security level may be assigned if the reflection pattern 450 corresponds to a frequently used parking lot. If there are no hits for the reflection pattern 450 among the reference reflection patterns 460, a lowest security level can be assigned. Unsafe known areas can also be assigned to the lowest security level. In this way, the disclosed techniques can offer an advantage that the “fingerprint” provided by the mobile device's scanning of the surrounding environment is a reliable piece of information that is not easily faked or hacked. Moreover, when UWB is used to provide this “scanning”, it provides a low-power and low-cost approach that is readily implemented in a wide range of different environments. Thus, compared to other approaches, these disclosed techniques can offer better security protection while also saving computer resources, such as saving/reducing memory needed, processor time used, and energy used.

Of course, the classification of the position (and accordingly the assignment of these security levels to the mobile device 100) can be carried out with more, fewer or different security levels, depending on the application.

The mobile device 100—in particular the processor 204—may further be configured to take the classification of the position (that is to say a result of the classification 730) as a basis for assigning the mobile device 100 (that is to say itself) a security level, for example the security level that corresponds to the classification of the position.

Optionally, the security level can be taken as a basis for carrying out, or undertaking, or facilitating, a matching security measure.

This is shown by way of illustration in the table in FIG. 5B.

A classification as “safe” (e.g. own garage), and a corresponding security level assigned to the mobile device 100, can result in a security measure that corresponds to this security level, for example full access to a vehicle, being granted, including administrator functions.

A classification with a medium security level (known parking lot, for example at the workplace), and a corresponding security level assigned to the mobile device 100, can result in a security measure that corresponds to this security level being carried out, e.g. a vehicle user being provided with entry information for the vehicle (or, for example, the vehicle being opened when the user approaches); however, access to sensitive settings may be restricted (and require an additional authentication, for example).

A classification of the reflection pattern 450 as belonging to an unsafe environment, and a corresponding security level assigned to the mobile device 100, can result in a security measure that corresponds to this security level being carried out. For example, the vehicle may be/remain locked and two-factor authentication can be requested in order to gain access to the vehicle.

Such classification-based assignment of a security level with a coordinated security measure can also be used, mutatis mutandis, in many other areas, for example when being admitted to a house (when a person receives, by means of the mobile device 100, a reflection pattern 450 that corresponds to their usual position when requesting admission, the mobile device 100, e.g. a smartphone that may be coupled to the door, can, if applicable, be classified as “safe” and the door can be opened), accessing a laptop as the mobile device 100 (e.g. said laptop does not request authentication when it is at a home desk, and requires two-factor authentication when it is not), etc.

In various exemplary embodiments, it is possible to use the above-outlined classification of the position with classification-based assignment of a security level (and, if applicable, application/facilitation of a matching security measure) using a movement pattern.

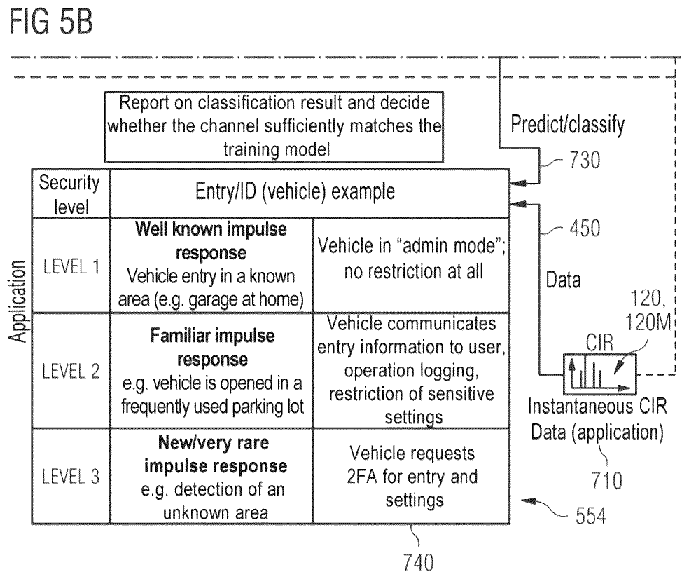

This is illustrated in FIG. 6: for each time in a sequence of times, a separate reflection pattern 450 can be determined and compared with a reference reflection pattern sequence stored in the database 446.

This permits for example access/admission to be granted only if the proximity scheme of the mobile device 100 is stored, and for example access/admission to be denied in the event of variances from the stored proximity scheme, even though, for example, a final position (e.g. user is in front of a front door with the mobile device 100) possibly matches. This can additionally increase security against unauthorized access.

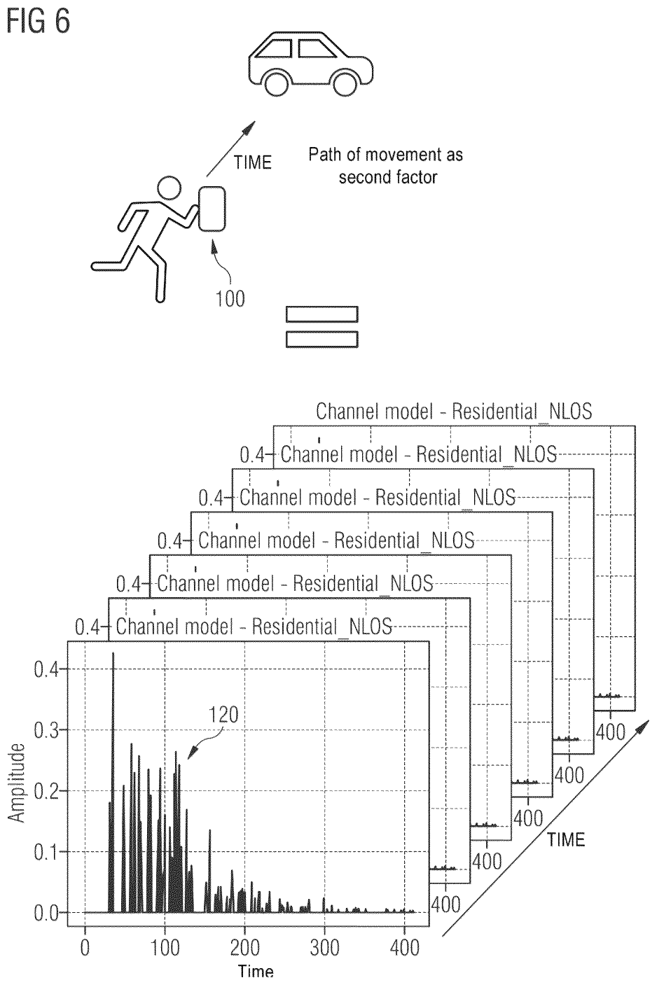

FIG. 7 shows a flowchart 700 for a method for assigning a security level of a mobile device according to various exemplary embodiments.

The method comprises receiving reflections of a radio pulse (710), determining a reflection pattern on the basis of the received reflections (720), undertaking or prompting classification of a position that the mobile device is in on the basis of the determined reflection pattern and at least one previously detected reference reflection pattern (730), and assigning a security level of the mobile device on the basis of the classification of the position (740).

As already mentioned above, in various exemplary applications, assignment of a security level of the mobile device 101 can possibly be dispensed with, but rather an indication of location can just be provided.

An appropriate security measure can optionally also be dispensed with in that case.

By way of example, a method for (e.g. UWB-based) determination of a present position can be provided.

For example, a database may contain reference reflection patterns 460 for all or substantially all positions of a (spatially restricted) environment, for example in a shopping center or a hotel.

In such a case, the method described above can be used to transmit the radio pulse 110 by means of the mobile device 100, to receive even the reflections 124, to determine the reflection pattern 450 and to classify said pattern on the basis of (e.g. publicly accessible) databases 446 in order to obtain the position of the mobile device 100.

In other words, the classification of the position may comprise assigning the determined reflection pattern a (real) location assigned to the appropriate reference reflection pattern 460.

This is, to some extent, also shown in the table in FIG. 5: for example, one of the reference reflection patterns 460 may have been assigned the location “own garage”. Another reference reflection pattern 460 may have been assigned a frequently used parking lot, for example in an underground parking garage at the workplace.

FIG. 8 shows a flowchart 800 for a method for determining a position according to various exemplary embodiments, for example using the mobile device 101.

The method comprises receiving reflections of a radio pulse (810), determining a reflection pattern on the basis of the received reflections (820) and determining a position of the mobile device on the basis of the determined reflection pattern and a plurality of previously detected reference reflection patterns from a plurality of positions (830).

Other characteristics of the mobile device 101 and the method that the mobile device 101 uses, for example, may be similar to those described above in connection with the mobile device 100, unless this has been explicitly ruled out or is self-evident.

Some exemplary embodiments are specified in summary below.

Exemplary embodiment 1 is a mobile device. The mobile device has a processor and a radio receiver that is configured to receive reflections of a radio pulse, the processor being configured to perform or prompt determination of a reflection pattern on the basis of received reflections, to undertake or prompt classification of a position of the mobile device on the basis of the determined reflection pattern and at least one previously detected reference reflection pattern, and being configured to assign a security level of the mobile device on the basis of the classification of the position.

Exemplary embodiment 2 is a mobile device according to exemplary embodiment 1, wherein the assigned security level is a highest security level from a plurality of different security levels, and wherein the processor is further configured to grant full access to the mobile device or a facility coupled to the mobile device.

Exemplary embodiment 3 is a mobile device according to exemplary embodiment 1, wherein the assigned security level is a medium security level from a plurality of different security levels, and wherein the processor is further configured to grant limited access to the mobile device or a facility coupled to the mobile device.

Exemplary embodiment 4 is a mobile device according to exemplary embodiment 1, wherein the assigned security level is a lowest security level from a plurality of different security levels, and wherein the processor is further configured to request an additional authentication for access to the mobile device or a facility coupled to the mobile device.

Exemplary embodiment 5 is a mobile device according to one of exemplary embodiments 1 to 4, wherein the determination of the reflection pattern comprises time-resolved measurement of intensities of the reflections.

Exemplary embodiment 6 is a mobile device according to one of exemplary embodiments 1 to 5, wherein the determination of the reflection pattern further comprises distinction of the reflections from reflections of a subsequent radio pulse.

Exemplary embodiment 7 is a mobile device according to one of exemplary embodiments 1 to 6, wherein the reflection pattern is constant when the mobile device is temporarily stationary and the source of the radio pulse is stationary.

Exemplary embodiment 8 is a mobile device according to one of exemplary embodiments 1 to 7, wherein the classification comprises implementation of a machine learning model using training data, the training data being formed by the at least one previously detected reference reflection pattern and a respective assigned security level from a plurality of security levels.

Exemplary embodiment 9 is a mobile device according to one of exemplary embodiments 1 to 7, wherein the at least one reference reflection pattern is stored in a database, and wherein the classification comprises comparison of the reflection pattern with the at least one reference reflection pattern.

Exemplary embodiment 10 is a mobile device according to exemplary embodiment 9, wherein each reference reflection pattern of the at least one reference reflection pattern has an assigned security level, and wherein the assignment of a security level of the mobile device comprises: if the reflection pattern matches one of the reference reflection patterns, assignment of the security level of the matching reference reflection pattern to the reflection pattern, and if the result of the comparison is that there is no matching reference reflection pattern, assignment of a lowest security level to the reflection pattern.

Exemplary embodiment 11 is a mobile device according to one of exemplary embodiments 1 to 10, wherein the processor is configured to carry out the determination of the reflection pattern and/or the classification of the position.

Exemplary embodiment 12 is a mobile device according to one of exemplary embodiments 1 to 11, wherein the processor is configured to prompt the determination of the reflection pattern and/or the classification of the position in an external data processing device.

Exemplary embodiment 13 is a mobile device according to one of exemplary embodiments 1 to 12, further comprising: a radio transmitter, wherein the processor is configured to prompt the radio transmitter to: transmit the radio pulse, or to transmit a request to transmit a radio pulse to an external radio transmitter.

Exemplary embodiment 14 is a mobile device according to one of exemplary embodiments 1 to 13, wherein the radio receiver is configured for communication by means of radio signals in a frequency range between approximately 3.5 GHZ and approximately 10 GHz.

Exemplary embodiment 15 is a mobile device according to one of exemplary embodiments 1 to 14, wherein the radio receiver is configured for ultra-wideband communication (UWB communication).

Exemplary embodiment 16 is a mobile device according to one of exemplary embodiments 1 to 15, wherein a pulse duration of the radio pulse is in a range between 1 ns and 5 ns.

Exemplary embodiment 17 is a mobile device according to one of exemplary embodiments 1 to 16, wherein the radio pulse is part of a sequence of radio pulses with a constant spacing, a pulse duration of each of the radio pulses being at most 10% of the distance between the radio pulses.

Exemplary embodiment 18 is a mobile device according to one of exemplary embodiments 1 to 17, which is implemented as a smartphone.

Exemplary embodiment 19 is a method for assigning a security level of a mobile device. The method comprises receiving reflections of a radio pulse, determining a reflection pattern on the basis of the received reflections, classifying a position that the mobile device is in on the basis of the determined reflection pattern and at least one previously detected reference reflection pattern, and assigning a security level of the mobile device on the basis of the classification of the position.

Exemplary embodiment 20 is a method according to exemplary embodiment 19, wherein the assigned security level is a highest security level from a plurality of different security levels, and wherein the method further comprises granting full access to the mobile device or a facility coupled to the mobile device.

Exemplary embodiment 21 is a method according to exemplary embodiment 19, wherein the assigned security level is a medium security level from a plurality of different security levels, and wherein the method further comprises granting limited access to the mobile device or a facility coupled to the mobile device.

Exemplary embodiment 22 is a method according to exemplary embodiment 19, wherein the assigned security level is a lowest security level from a plurality of different security levels, and wherein the method further comprises requesting an additional authentication for access to the mobile device or a facility coupled to the mobile device.

Exemplary embodiment 23 is a method according to one of exemplary embodiments 19 to 22, wherein the determination of the reflection pattern comprises time-resolved measurement of intensities of the reflections.

Exemplary embodiment 24 is a method according to one of exemplary embodiments 19 to 23, wherein the determination of the reflection pattern further comprises distinction of the reflections from reflections of a subsequent radio pulse.

Exemplary embodiment 25 is a method according to one of exemplary embodiments 19 to 24, wherein the reflection pattern is constant when the mobile device is temporarily stationary and the source of the radio pulse is stationary.

Exemplary embodiment 26 is a method according to one of exemplary embodiments 19 to 25, wherein the classification comprises implementation of a machine learning model using training data, the training data being formed by the at least one previously detected reference reflection pattern and a respective assigned security level from a plurality of security levels.

Exemplary embodiment 27 is a method according to one of exemplary embodiments 19 to 25, wherein the at least one reference reflection pattern is stored in a database, and wherein the classification comprises comparison of the reflection pattern with the at least one reference reflection pattern.

Exemplary embodiment 28 is a method according to exemplary embodiment 27, wherein each reference reflection pattern of the at least one reference reflection pattern has an assigned security level, and wherein the classification comprises: if the reflection pattern matches one of the reference reflection patterns, assignment of the security level of the matching reference reflection pattern to the reflection pattern, and if the result of the comparison is that there is no matching reference reflection pattern, assignment of an unsafe security level to the reflection pattern.

Exemplary embodiment 29 is a method according to one of exemplary embodiments 19 to 28, wherein the determination of the reflection pattern and/or the classification of the position is/are carried out within the mobile device.

Exemplary embodiment 30 is a method according to one of exemplary embodiments 19 to 30, wherein the determination of the reflection pattern and/or the classification of the position are/is prompted in the mobile device and carried out in an external data processing device.

Exemplary embodiment 31 is a method according to one of exemplary embodiments 19 to 30, further comprising: transmitting the radio pulse by means of the mobile device that receives the reflections, or transmitting a request to transmit a radio pulse to an external radio transmitter by means of the mobile device.

Exemplary embodiment 32 is a method according to one of exemplary embodiments 19 to 31, wherein the radio pulse has a frequency in a frequency range between approximately 3.5 GHz and approximately 10 GHz.

Exemplary embodiment 33 is a method according to one of exemplary embodiments 19 to 32, wherein the radio pulse is part of an ultra-wideband communication (UWB communication).

Exemplary embodiment 34 is a method according to one of exemplary embodiments 19 to 33, wherein a pulse duration of the radio pulse is in a range between 1 ns and 5 ns.

Exemplary embodiment 35 is a method according to one of exemplary embodiments 19 to 34, wherein the radio pulse is part of a sequence of radio pulses with a constant spacing, a pulse duration of each of the radio pulses being at most 10% of the distance between the radio pulses.

Exemplary embodiment 36 is a method for determining a position of a mobile device. The method comprises receiving reflections of a radio pulse, determining a reflection pattern on the basis of the received reflections and determining a position of the mobile device on the basis of the determined reflection pattern and a plurality of previously detected reference reflection patterns from a plurality of positions.

Exemplary embodiment 37 is a method according to exemplary embodiment 36, which further comprises providing the determined position to a user.

Exemplary embodiment 38 is a method according to exemplary embodiment 36 or 37, wherein the determination of a position comprises implementation of a machine learning model using training data, the training data being formed by the at least one previously detected reference reflection pattern and a respective assigned position from a plurality of positions.

Exemplary embodiment 39 is a method according to exemplary embodiment 36 or 37, wherein the at least one reference reflection pattern is stored in a database, and wherein the determination of a position comprises comparison of the reflection pattern with the at least one reference reflection pattern.

Exemplary embodiment 40 is a method according to exemplary embodiment 39, wherein each reference reflection pattern of the at least one reference reflection pattern has an assigned position, and wherein the comparison comprises: if the result of the comparison is that the reflection pattern matches one of the reference reflection patterns, assignment of the position of the matching reference reflection pattern to the reflection pattern, and if the result of the comparison is that there is no matching reference reflection pattern, assignment of “position unknown” to the reflection pattern.

Exemplary embodiment 41 is a mobile device. The mobile device has a processor and a radio receiver that is configured to receive reflections of a radio pulse, the processor being configured to perform or prompt determination of a reflection pattern on the basis of received reflections and to perform or prompt determination of a position of the mobile device on the basis of the determined reflection pattern and a plurality of previously detected reference reflection patterns from a plurality of positions.

Exemplary embodiment 42 is a mobile device according to exemplary embodiment 41, wherein the processor is further configured to provide the determined position to a user.

Exemplary embodiment 43 is a mobile device according to exemplary embodiment 41 or 42, wherein the determination of a position comprises implementation of a machine learning model using training data, the training data being formed by the at least one previously detected reference reflection pattern and a respective assigned position from a plurality of positions.

Exemplary embodiment 44 is a mobile device according to exemplary embodiment 41 or 42, wherein the at least one reference reflection pattern is stored in a database, and wherein the determination of a position comprises comparison of the reflection pattern with the at least one reference reflection pattern.

Exemplary embodiment 45 is a mobile device according to exemplary embodiment 41 or 42, wherein each reference reflection pattern of the at least one reference reflection pattern has an assigned position, and wherein the comparison comprises: if the result of the comparison is that the reflection pattern matches one of the reference reflection patterns, assignment of the position of the matching reference reflection pattern to the reflection pattern, and if the result of the comparison is that there is no matching reference reflection pattern, assignment of “position unknown” to the reflection pattern.

Exemplary embodiment 46 is a permanent computer-readable medium containing instructions that, when executed by means of a processor of a mobile device, lead to a radio receiver of the mobile device receiving reflections of a radio pulse, taking the received reflections as a basis for determining a reflection pattern or prompting the determination, undertaking or prompting classification of a position of the mobile device on the basis of the determined reflection pattern and at least one previously detected reference reflection pattern, and assigning a security level of the mobile device on the basis of the classification of the position.

Exemplary embodiment 47 is a computer-readable memory containing instructions that, when executed, are implemented by a mobile device according to one of exemplary embodiments 1 to 18 or 41 to 45.

Further advantageous configurations of the device emerge from the description of the method and vice versa.

What is claimed is:

1. A mobile device, containing:
a processor;
a memory that stores instructions executable by the processor;
a radio receiver configured to receive reflections of a radio pulse;
the instructions being configured to cause the processor:
to perform or prompt determination of a reflection pattern based on the received reflections;
to undertake or prompt classification of a position that the mobile device is in on the basis of the determined reflection pattern and at least one previously detected reference reflection pattern; and
to assign a security level of the mobile device based on the classification of the position.

2. The mobile device as claimed in claim 1,
wherein the assigned security level is a highest security level from a plurality of different security levels; and
wherein the processor is further configured to grant full access to the mobile device or a facility coupled to the mobile device.

3. The mobile device as claimed in claim 1,
wherein the assigned security level is a medium security level from a plurality of different security levels; and
wherein the processor is further configured to grant limited access to the mobile device or a facility coupled to the mobile device.

4. The mobile device as claimed in claim 1,
wherein the assigned security level is a lowest security level from a plurality of different security levels; and
wherein the processor is further configured to request an additional authentication for access to the mobile device or a facility coupled to the mobile device.

5. The mobile device as claimed in claim 1,
wherein the determination of the reflection pattern comprises time-resolved measurement of intensities of the reflections.

6. The mobile device as claimed in claim 1,
wherein the determination of the reflection pattern further comprises distinction of the reflections from reflections of a subsequent radio pulse.

7. The mobile device as claimed in claim 1,
wherein the reflection pattern is constant when the mobile device is temporarily stationary and a source of the radio pulse is stationary.

8. The mobile device as claimed in claim 1,
wherein the classification comprises implementation of a machine learning model using training data, the training data being formed by the at least one previously detected reference reflection pattern and a respective assigned security level from a plurality of security levels.

9. The mobile device as claimed in claim 1,
wherein the at least one reference reflection pattern is stored in a database; and
wherein the classification comprises comparison of the reflection pattern with the at least one reference reflection pattern.

10. The mobile device as claimed in claim 9,
wherein each reference reflection pattern of the at least one reference reflection pattern has an assigned security level; and
wherein the assignment of a security level of the mobile device comprises:
when the reflection pattern matches one of the reference reflection patterns, assignment of the security level of the matching reference reflection pattern to the reflection pattern; and
when a result of the comparison is that there is no matching reference reflection pattern, assignment of a lowest security level to the reflection pattern.

11. A method for assigning a security level of a mobile device, the method comprising:
receiving reflections of a radio pulse;
determining a reflection pattern based on the received reflections;
classifying a position that the mobile device is in based on the determined reflection pattern and at least one previously detected reference reflection pattern; and
assigning a security level of the mobile device based on the classification of the position.

12. The method as claimed in claim 11,
wherein the assigned security level is a highest security level from a plurality of different security levels; and
wherein the method further comprises granting full access to the mobile device or a facility coupled to the mobile device.

13. The method as claimed in claim 11,
wherein the assigned security level is a medium security level from a plurality of different security levels; and
wherein the method further comprises granting limited access to the mobile device or a facility coupled to the mobile device.

14. The method as claimed in claim 11,
wherein the assigned security level is a lowest security level from a plurality of different security levels; and
wherein the method further comprises requesting an additional authentication for access to the mobile device or a facility coupled to the mobile device.

15. The method as claimed in claim 11,
wherein the determination of the reflection pattern comprises time-resolved measurement of intensities of the reflections.

16. The method as claimed in claim 11,
wherein the determination of the reflection pattern further comprises distinction of the reflections from reflections of a subsequent radio pulse.

17. The method as claimed in claim 11,
wherein the classification comprises implementation of a machine learning model using training data, the training data being formed by the at least one previously detected reference reflection pattern and a respective assigned security level from a plurality of security levels.

18. The method as claimed in claim 11,
wherein the at least one reference reflection pattern is stored in a database; and
wherein the classification comprises comparison of the reflection pattern with the at least one reference reflection pattern.

19. The method as claimed in claim 11, further comprising:
transmitting the radio pulse by means of the mobile device that receives the reflections, or
transmitting a request to transmit a radio pulse to an external radio transmitter by means of the mobile device.

20. A mobile device, containing:
a processor;
a memory that stores instructions executable by the processor;
a radio receiver configured to receive reflections of a radio pulse;
the instructions being configured to cause the processor:
to perform or prompt determination of a reflection pattern based on received reflections; and
to perform or prompt determination of a position of the mobile device based on the determined reflection pattern and a plurality of previously detected reference reflection patterns from a plurality of positions.
